(19) United States
(12) Patent Application Publication
(10) Pub. No.: US 2026/0259002 A1
(43) Pub. Date: Sep. 3, 2026

(54) APPARATUS AND METHOD FOR DRYING A WEB COATED WITH MATERIAL, AND SYSTEM COMPRISING THE APPARATUS

(71) Applicant: Durr Systems Inc., Southfield, MI (US)

(72) Inventors: Joshua Smith, Southfield, MI (US); Joseph Kulkarni, Southfield, MI (US)

(21) Appl. No.: 19/066,284

(22) Filed: Feb. 28, 2025

(51) Int. Cl. F26B 13/20; B65H 16/02; B65H 23/24

(52) U.S. Cl. CPC F26B 13/104; B65H 16/02; B65H 23/24

(57) ABSTRACT

Provided is an apparatus for drying a web coated with material. The apparatus includes a guiding system configured to guide the web along a linear path through the apparatus. Additionally, the apparatus includes an air flow system configured to cause a flow of drying air along the web for drying the web.

### FIELD

The present disclosure relates to drying of coated webs. In particular, examples of the present disclosure relate to an apparatus and method for drying a web coated with material, and a system comprising the apparatus.

### BACKGROUND

In various industrial processes, webs coated with materials such as adhesives, coatings or electrode slurries require efficient drying to ensure product quality and performance. As industries continue to demand higher throughput and improved coating performance, existing drying technologies may face limitations in terms of efficiency, scalability and operational costs.

Hence, there may be a demand for improved drying of coated webs.

### SUMMARY

The demand may be satisfied by the subject-matter of the appended claims.

According to a first aspect, the present disclosure provides an apparatus for drying a web coated with coating material. The web refers to the underlying material that serves as a substrate for the coating material. The web may be a continuous, flexible material such as foil, paper, plastic film, or textile. Similarly, the coating material may vary and include adhesives, slurries, inks or chemical coatings. For example, in the production of electrodes for batteries, the web may be a thin metal foil (e.g., copper for anodes and aluminum for cathodes) or any other conductive sheet-like structure and the coating material may be a mixture of active material (such as graphite for anodes or lithium cobalt oxide for cathodes) mixed with a binder (e.g., PolyYinyliDene Fluoride, PVDF) and conductive additives (e.g., carbon black) suspended in a solvent (e.g., N-Methyl-2-Pyrrolidone, NMP). However, the present disclosure is not limited thereto. The apparatus may accommodate various webs and coating materials depending on the product to be manufactured.

The apparatus comprises a guiding system configured to guide the web along a linear path through the apparatus. The guiding system is a system configured to ensure that the web moves in a controlled manner through the apparatus along the linear path. For example, the guiding system may be configured to keep the web stable, aligned and properly tensioned during the drying process (i.e., while passing through the apparatus). The guiding system may, e.g., be a mechanical guiding system, a pneumatic guiding system or a combination of both. The linear path refers to the intended trajectory along which the web progresses through the apparatus. This path may be geometrically straight or represent a general direction of movement, allowing for cross-apparatus (cross-machine) movements or oscillations of the web around the path during transport. The cross-apparatus movements or oscillations may refer to displacements of the web relative to the path, ensuring that the web remains within a controlled range while being transported. According to examples, said cross-apparatus movements or oscillations shall be less than 100 mm, preferred less than 50 mm, more preferred less than 10 mm or even less approaching values near zero. In another aspect, a tolerance of said cross-apparatus movements or oscillations is preferred to be better than ±5 mm, even more preferred less than ±2 mm, and ideally up to ±1 mm. The web may follow the linear path with vertical displacements, resulting in a movement pattern that may resemble a sinusoidal or undulating motion while maintaining overall alignment with the path's primary direction.

Additionally, the apparatus comprises an air flow system configured to cause a flow of drying air along the web for drying the web. In other words, the air flow system is configured to direct a controlled flow of drying air over or along the surface(s) of the coated web to remove moisture or solvents from the coating. In still other words, the air flow system is configured to direct drying air along the surface(s) of the web to evaporate or cure the coating material. The drying air refers to a stream of air with predefined characteristics such as one or more of temperature, moisture content, dew point, velocity and pressure.

The apparatus according to the first aspect allows to substantially reduce drying time and increase production throughput. For example, the apparatus according to the first aspect may process multiple meters of web per minute. As a comparison, conventional batch vacuum drying methods take 24 to 48 hours to dry a single roll of coated web. The significantly reduced drying time allows for higher throughput and seamless integration into production processes. Additionally, the apparatus according to the first aspect allows to achieve effective drying using room temperature air at high velocities, eliminating the need for vacuum pumps or heaters, thereby lowering operational and energy costs. The apparatus according to the first aspect enables efficient and continuous drying of coated webs, enhancing production speed and simplifying the drying process. By utilizing an air flow system to direct drying air along the web, the apparatus ensures consistent and uniform drying while the guiding system maintains controlled movement of the web through the apparatus. This combination reduces drying inconsistencies and improves product quality. The apparatus is also flexible and adaptable, allowing adjustments to accommodate different materials, coatings, and production environments, making it suitable for a wide range of applications.

According to examples, the web received by the apparatus may be pre-dried, meaning that it has already undergone a prior drying stage and has a solid content of at least 99.8% by weight. In other words, the moisture or solvent content is 0.2% or less by weight. A pre-dried web retains only minimal residual moisture or solvent. The apparatus according to the first aspect allows to efficiently remove remaining traces of moisture and optimize the final properties of the coating while operating with reduced drying time. For example, the apparatus according to the first aspect may be used in a final drying step or process to ensure the web meets pre-defined moisture and/or solvent content requirements (targets). The apparatus according to the first aspect is particularly advantageous for applications requiring precise control over residual moisture or solvent levels, such as battery electrode manufacturing, pharmaceutical coatings, or high-performance adhesive layers.

In some examples, the guiding system may comprise a plurality of rollers (i.e., two or more rollers) configured to guide the web along the linear path. For example, the plurality of rollers may be arranged along the linear path to guide the web. A roller refers to a cylindrical component that rotates around its central axis and is configured to guide, support, or transport the web along the linear path of the apparatus. The roller may engage with the web either through direct mechanical contact or by applying tension or pressure to ensure controlled movement. The plurality of rollers may comprise idler rollers, which rotate passively as the web moves over them, driven rollers, which are actively powered to advance the web through the apparatus, or a combination of both. The roller surface may be smooth or textured, and it may be constructed from materials such as metal, rubber, or composite materials, depending on the properties of the web and coating material. The rollers maintain the web's position and tension, ensuring it follows the intended linear path through the apparatus. Rollers provide consistent and controlled mechanical guidance to the web, minimizing deviations from the linear path. This ensures that the web moves smoothly through the apparatus, preventing issues like wrinkling, skewing, or misalignment, which could otherwise result in uneven drying or coating defects. Rollers help keep the web flat and aligned, ensuring that the coated surface maintains consistent proximity to the drying air. Uniform exposure to the drying air results in consistent drying across the web's surface, improving product quality. Roller-based guiding systems are mechanically simple, requiring minimal components and maintenance. This reduces production and operational costs compared to more complex guiding systems. In some examples, the plurality of rollers may comprise a least one sensing roller. A sensing roller is a roller equipped with (comprising) at least one sensor or a sensor array. For example, the roller may be equipped with one or more of a temperature sensor or sensor array, a moisture sensor or sensor array, an optical surface sensor or sensor array, or an electrical or electromagnetic sensor or sensor array. The at least one sensing roller allows to measure one or more properties of the web such as a (local) web temperature, a (local) web residual moisture or a (local) web conductivity. For example, rollers, as described in patent publications U.S. Pat. No. 12,130,184 B2 and US 2024/0384981 A1, may be used for the one or more sensing rollers. The one or more measured properties of the web may be used for controlling the flow of drying air along the web (in real-time). For example, the velocity, the volume flow per unit time or the temperature of the drying air may be controlled (adjusted) based on the one or more measured properties of the web (in particular based on one or both of the measured residual moisture and temperature of the web). This allows real-time adaption of the operation of the apparatus according to the first aspect to the properties of the web.

Alternatively or additionally, the guiding system may comprise a plurality of air bars (i.e., two or more air bars) arranged below the web and configured to continuously support and guide the web along the linear path by generating an airflow that floats the web above the air bars. The air bars are elongated components of the air flow system that extend across the width of the web and are arranged in a plurality along the transport direction of the web. The length of an individual air bar may be greater than, equal to, or less than the width of the web. The air bar length may be selected based on various parameters such as system design and/or process requirements. In some examples, the width of the air bar may be significantly larger than the web width, in which case the apparatus may include adjustable devices or flow restriction mechanisms to limit the effective width of the airflow to match the respective web width. Conversely, the guiding system may comprise multiple narrower air bars, positioned side by side, effectively forming a wider air bar configuration tailored to the web's width. The air bars are configured to direct controlled streams of air toward the web. Each air bar comprises one or more air outlets or nozzles designed to emit airflow at one or more predefined angles, velocities, or patterns. For example, the plurality of air bars may be arranged along the linear path to guide the web. The air bars are positioned beneath the web, and configured to direct air upwards to lift and stabilize the web during drying. The air bars generate an upward airflow that creates a cushion of air, allowing the web to float above the air bars as it moves along the linear path. For example, air foils, as described in patent publications US 2005/0223593 A1 and US 2008/0276488 A1, may be used for the air bars. This non-contact guiding method may replace or complement mechanical guiding systems like rollers. The air bars guide the web without physical contact, minimizing abrasion, scratches, or deformation of the web and coating material. This is particularly advantageous for delicate or freshly coated webs that are vulnerable to mechanical damage during drying. By eliminating mechanical contact points between the web and the guiding system, the risk of web tears, folds, or wrinkles is significantly reduced. This decreases material waste and enhances production yield, improving overall efficiency.

The web has two opposite surfaces (e.g., bottom and top surface). According to examples, each may be coated with the material. In other words, the web may be coated on both sides. In these examples, the air flow system may be configured to direct the drying air along both surfaces of the web. That is, the air flow system may be configured to direct drying air to both surfaces of the web as it moves through the apparatus. The drying air is directed at each side of the web by the air flow system. In other words, the air flow system is configured to deliver drying air to both sides of the web at the same time as the web moves through the apparatus. Accordingly, both opposite surfaces (e.g., the top and bottom surfaces) of the web receive airflow concurrently. By directing drying air to both surfaces of the web at the same time, the apparatus dries the entire web uniformly and efficiently. This reduces drying time compared to systems that dry only one side at a time, allowing for faster processing speeds and higher throughput. Dual-sided drying allows for continuous, high-speed drying without the need to flip or reprocess the web. This enhances production efficiency, making the apparatus suitable for large-scale manufacturing. Drying both surfaces simultaneously ensures that both coatings cure evenly, minimizing the risk of cracking, peeling, or inconsistencies between the two coated surfaces. This leads to higher product quality, e.g., for battery electrodes, packaging films, and printed electronics that require precise coating uniformity. When only one side of the web is dried, the material may experience thermal expansion or shrinkage on that side, causing the web to curl or warp. By applying drying air to both sides, thermal forces are balanced, preventing deformation. This preserves the web's structural integrity, reducing material waste and improving downstream processing. Simultaneous drying of both surfaces reduces the need for multiple drying passes, minimizing energy consumption. This lowers operational costs and enhances the apparatus's sustainability by reducing drying times and power usage.

In some examples, the air flow system is configured to direct equal amounts of drying air along both surfaces of the web. The drying air applied to both surfaces of the web by the air flow system is balanced to ensure uniform drying across both coated surfaces in these examples. For example, the drying air applied to both surfaces of the web may be balanced in terms of one or more of volume, mass, velocity and pressure. In other words, the same volume or mass of drying air may be directed along both surfaces of the web. Equal distribution of drying air prevents over-drying on one side and under-drying on the other, ensuring both surfaces dry at the same rate. In particular, if both sides of the web carry the same amount of coating (in thickness, density, etc.) and/or the same coating (by composition). This minimizes the risk of coating inconsistencies, cracks, or uneven textures, improving the overall quality of the final product. Uneven drying may result in differential shrinkage or expansion between the two surfaces, causing the web to curl or warp. By applying equal airflow to both sides, the forces on the web remain balanced. This prevents distortion of the web, preserving dimensional stability and reducing material waste.

It should be noted that the apparatus is not limited to drying webs with dual-sided coatings. In other examples, the web may have two opposite surfaces (e.g., bottom and top surface), wherein only one of the two surfaces is coated with the coating material. In these examples, the air flow system may be configured to direct the drying air along both surfaces of the web or only along the surface coated with the coating material.

According to some examples, the air flow system is configured to direct the drying air in the same direction as a transport direction of the web. The transport direction of the web refers to the linear path along which the web is guided through the apparatus. In these examples, the airflow moves parallel to and in the same direction as the web's movement through the apparatus. In other words, the air flow system may be configured for co-flow drying. In the co-flow configuration, the drying air maintains consistent contact with the coated surface(s) of the web over an extended period. This allows for effective moisture or solvent removal, especially for thicker coatings or slower-drying coating materials. The co-flow air movement may further minimize turbulence and pressure imbalances around the web. This may prevent fluttering or misalignment of the web, ensuring consistent transport through the apparatus and uniform drying across the entire surface.

In alternative examples, the air flow system is configured to direct the drying air in a direction opposite to the transport direction of the web. In these examples, the drying air moves against the motion of the web, creating a higher relative velocity between the drying air and the web's surface(s). In other words, the air flow system may be configured for counter-flow drying. As the drying air flows in reverse relative to the web's forward transport direction, the interaction between the air and the web is maximized, enhancing drying efficiency. The counter-flow air movement creates a higher relative velocity between the drying air and the web's surface(s), increasing heat and mass transfer rates. This accelerates moisture or solvent removal, making it ideal for drying thicker or slower-drying coatings. Since the drying air moves in the opposite direction, any moisture or solvent evaporated from the coating is carried away from the downstream sections of the web. This prevents re-wetting of previously dried sections, improving coating consistency and product quality.

In the above examples, the air flow system is configured to cause the flow of drying air parallel to the linear path. In other words, the air flow system is configured to direct the drying air parallel to the linear path of the web as it moves through the apparatus. This means the drying air flows in alignment with the trajectory of the web, regardless of whether the flow is co-flow (same direction) or counter-flow (opposite direction). The parallel alignment of the drying air ensures consistent interaction with the web along its path.

According to some examples, the air flow system is configured to direct the drying air at a velocity of at least 1.25 meters per second (250 feet per minute) along the web. The velocity is measured relative to the fixed (non-moving) components of the apparatus (e.g., a frame of the apparatus). This ensures that the drying air moves with sufficient speed to effectively interact with the web's coated surface(s) for optimal drying performance. In some examples, the air flow system may be configured to direct the drying air at a velocity of about 2.5 meters per second (500 feet per minute) along the web.

According to some examples, the guiding system and the air flow system are formed jointly (integrally) and comprise a first set of horizontally spaced apart air bars, and a second set of horizontally spaced apart air bars. The first and second sets of air bars are vertically spaced apart from each other. The air bars in each set are horizontally spaced apart from each other by a distance of at least 38 centimeters (15 inches) along the transport direction of the web. In other words, the individual air bars within each set (whether the first set or the second set) are positioned with a minimum horizontal gap of 38 centimeters between them. This spacing refers to the distance between adjacent air bars in the same set as they are aligned parallel to each other along the web's path. The minimum horizontal spacing of 38 centimeters ensures proper airflow distribution and stability. The air bars in the first set are configured to direct drying air at one or more angles to a first surface of the web (e.g., a top surface of the web). The air bars in the second set are configured to direct the drying air at one or more angles to an opposite second surface of the web (e.g., a bottom surface of the web). The drying air is directed to pass along the web to guide the web between the sets of air bars and to dry the web. The air bars in each set of air bars are elongated components that extend across the width of the web and are arranged in a plurality along the transport direction of the web on the respective side of the web. Each air bar comprises one or more air outlets or nozzles designed to emit airflow at one or more predefined angles, velocities, or patterns. In these examples, the air bars serve dual purposes: 1) guiding the web by creating stabilizing airflow to maintain alignment, and 2) drying the web by directing controlled air along the web to evaporate moisture or solvents from the coated material. The first set of air bars and the second set of air bars are positioned at different vertical levels within the apparatus, with the web passing between them. The vertical spacing provides enough room for the web to move along its linear path, while allowing each set of air bars to direct drying air toward its respective surface of the web. The air bars guide the web without physical contact, reducing the risk of scratches, deformation, or damage to sensitive coatings. This is especially beneficial for delicate webs or freshly coated materials. The air bars in the first and second sets direct air to the top and bottom surfaces simultaneously, ensuring uniform drying. This reduces drying time and prevents inconsistencies between the two coated surfaces, such as warping, curling, or uneven thickness. By integrating guiding and drying systems into a single design, the apparatus eliminates the need for separate components, reducing mechanical complexity.

In some examples, the air bars in each set are horizontally spaced apart from each other by a distance of less than 80 cm (31.5 inches). This means that the gap between adjacent air bars in the same set is less than 80 cm, ensuring effective airflow coverage and interaction with the web along its path. The airflow from adjacent air bars may overlap or complement each other, minimizing gaps or inconsistencies in drying or guiding forces. For example, the air bars in each set may be horizontally spaced apart from each other by a distance between 38 centimeters (15 inches) and 76 centimeters (30 inches).

According to some examples, the air bars in each set may be configured to direct the drying air to the respective surface at a velocity of at least 15 meters per second (3000 feet per minute). The velocity is again measured relative to the fixed (non-moving) components of the apparatus (e.g., a frame of the apparatus). This ensures that the drying air moves with sufficient speed to effectively interact with the web's coated surface(s) for optimal guiding and drying performance. In some examples, the air bars in each set may be configured to direct the drying air to the respective surface at a velocity of about 30.5 meters per second (6000 feet per minute).

In some examples, the drying air may be at a temperature of 30° C. (i.e., 86° F.) or lower. In other words, drying air at room temperature rather than heated air may be used. Operating the apparatus with unheated or minimally conditioned air significantly reduces energy consumption, as heating elements are not required. This lowers operational costs and contributes to a more sustainable drying process, aligning with energy-saving goals in industrial applications. Additionally, low-temperature drying air prevents heat damage to sensitive coatings or webs. This ensures the integrity and functionality of the coating and the underlying web material. For example, some web materials, such as plastic films or thin metal foils, may warp, expand, or shrink under high temperatures. Low-temperature drying prevents these deformations. Avoiding heated air reduces the risks associated with high-temperature equipment, such as burns or fire hazards. This improves the safety of the operating environment for workers.

According to some examples, a dew point of the drying air is −30° C. (i.e., −22° F.) or below. This ensures that the drying air has extremely low moisture content, enhancing its effectiveness in removing moisture or solvents from the coated web during the drying process. A dew point of −30° C. means the air is highly dry and has a very low water vapor content, which is beneficial for applications that demand precise drying conditions. For example, the dew point of the drying air may be −35° C. (i.e., −31° F.).

In some examples, the apparatus further comprises an outlet for outputting part of the drying air after it has passed along the web to an external device for reuse. The outlet allows a portion of the drying air, after it has interacted with the web, to be directed to an external device for reuse. The outlet serves as a controlled exit point for the drying air, directing it to an external device for reuse or further processing. The outlet may comprise one or more of valves, ducts, fans (blowers) or other flow control mechanisms to regulate the volume and direction of the drying air being discharged. The drying air that exits through the outlet has already been used to remove moisture or solvents from the coated web. The drying air that exits through the outlet is exhaust air of the apparatus. The outlet makes the exhaust air available for further processing or applications outside the drying apparatus. By leveraging drying air that has already served its primary purpose in the drying process, the energy efficiency and sustainability is increased. This may in turn lower operational costs. The external device may be manifold. For example, if the apparatus is used as a secondary dryer, the external device may be a primary drying system upstream of the apparatus. In other examples, the external device may perform a secondary process using pre-dried air such as cooling, heating or solvent recovery.

According to some examples, the apparatus may further comprise a recycling system. The recycling system is a dedicated subsystem within the apparatus responsible for handling the drying air after its initial use. The recycling system is configured to receive at least part (e.g., 50% or more, 75% or more, 90 or more, or 100%) of the drying air after it has passed along the web. In other words, the recycling system is configured to collect drying air that has passed along the web. This may include drying air with residual moisture, solvent vapors, or other by-products. Furthermore, the recycling system is configured to condition the received drying air and supply the conditioned air to the air flow system for reuse in the apparatus. In other words, the recycling system is configured to process the collected air to restore it to predefined (target, desired) properties. The conditioning of the received drying air may comprise various processes such as one or more of dehumidification (removing of moisture), filtration (eliminating particulate matters of impurities), temperature adjustment (cooling or reheating the air) and solvent recovery (capturing and optionally recycling of evaporated solvents, such as NMP in battery electrode production). The conditioned air is reintroduced by the recycling system, ensuring it can perform effectively in subsequent drying cycles. By recycling and reusing drying air, the apparatus minimizes the need for external air, significantly reducing energy consumption. This lowers operational costs and improves the sustainability of the drying process. The conditioning process further ensures that the air is restored to its optimal drying properties, such as low moisture content or appropriate temperature. This improves the effectiveness of the drying system, ensuring consistent results across multiple cycles.

As described above, the conditioning of the received drying air may comprise dehumidification. Accordingly, in some examples, the recycling system comprises a dehumidifier configured to reduce the moisture content of the received drying air to condition it for reuse in the apparatus. The dehumidifier is configured to actively reduce the moisture content of the received air (e.g., to meet a predefined/target dew point or humidity level for efficient drying). The dehumidifier ensures that the air is sufficiently dry to be reused effectively in the apparatus, maintaining optimal drying conditions for the web. For example, the dehumidifier may be or comprise a desiccant wheel dehumidifier. The desiccant wheel dehumidifier comprises a rotating wheel containing a hygroscopic material (e.g., silica gel or molecular sieves) that adsorbs moisture from the drying air as it passes through. The wheel rotates into a regeneration zone where the moisture is removed (typically by heating), allowing the desiccant to be reused. The desiccant wheel dehumidifier is ideal for achieving extremely low dew points (e.g., −30° C. or below). However, the present disclosure is not limited to desiccant wheel dehumidifiers. In alternative examples, the dehumidifier may be or comprise one or more of a refrigeration-based dehumidifier, an adsorption tower dehumidifier, a membrane-based dehumidifier and chemical absorption dehumidifier instead or in addition to the desiccant wheel dehumidifier.

In some examples, the recycling system is configured to receive supplemental air (make up air) and mix it with the received drying air. This enhances the flexibility and adaptability of the recycling system by allowing the introduction of external air (fresh or pre-conditioned) to improve the quality or properties of the air being reused. The supplemental air may be manifold. For example, the supplemental air may be (e.g., conditioned) ambient air, dry room air drawn from a dry room or air from any other external source such as an external air supply system. The supplemental air is combined by the recycling system with the air that has been received from the drying process. This mixing step ensures that the resulting air meets the desired quality and operational parameters. The supplemental air is introduced at a suitable stage in the recycling process, such as before or after dehumidification or conditioning. Mixing supplemental air allows the system to restore or improve the quality of the recycled air by adjusting properties such as humidity, temperature, or oxygen levels. This ensures that the recycled air is optimized for reuse, enhancing drying efficiency and consistency. During the drying process, some air may be lost due to exhaust or leaks. Supplemental air replenishes these losses, maintaining the required air volume in the system. This ensures continuous operation without interruptions, even in high-throughput production environments.

According to some examples, the apparatus may further comprise an inlet for coupling to an external source providing the drying air. The inlet enables the apparatus to utilize pre-conditioned or specially treated air from an external system, enhancing flexibility, adaptability, and operational efficiency. The external source provides drying air with predefined or target properties (e.g., temperature and humidity) to support the drying process. The external source may include systems like dry rooms, air handling units or other specialized air treatment systems. By sourcing drying air from an external system, the apparatus can receive air with precisely controlled properties, such as low humidity or specific temperatures. This ensures consistent drying performance, even in environments with fluctuating conditions. If the external source provides pre-conditioned air, the apparatus does not need to incorporate air conditioning systems (e.g., dehumidifiers). This simplifies the design of the apparatus, reduces energy consumption, and lowers maintenance costs.

According to a second aspect, the present disclosure provides a system comprising an apparatus for drying a web coated with coating material according to the first aspect. The system additionally comprises a coating device configured to coat the web with the coating material. The coating device may be any device, machine or mechanism configured to apply coating material to the web. For example, the coating device may be configured to intermittently coat the web with the coating material (this is also known as “skip coating”). However, the coating device is not limited thereto. In other examples, the coating device may be configured to continuously coat the web with the coating material (this is also known as “slot die coating”). As described above, the web and the coating material may vary depending on the application. For example, the system may be used for the manufacture of battery electrodes (e.g., apply a mixture of active material mixed with a and conductive additives suspended in a solvent to a thin metal foil), printed electronics (e.g., apply conductive inks or materials only to specific areas of a substrate for circuit paths, etc.) or medical devices (e.g., coat specific parts of medical devices or implants with biocompatible or drug-releasing materials). The apparatus according to the first aspect supports high-throughput manufacturing, making the coating system suitable for industrial-scale applications. Additionally, operational and energy costs may be lowered compared to conventional coating systems as the apparatus according to the first aspect does not need vacuum pumps or heaters.

The coating system may accommodate various coating materials and thicknesses, as well as web types, by adjusting parameters in both the coating device and the apparatus according to the first aspect. This makes the coating system adaptable for diverse industries, including battery manufacturing, printing, packaging, and electronics. Accordingly, examples of the present disclosure relate to the use of the apparatus according to the first aspect in one of the industries mentioned herein, in particular in the manufacture of batteries. In other words, examples of the present disclosure relate to a method for battery manufacturing that uses the apparatus according to the first aspect (e.g., for secondary drying).

In some examples, the coating system further comprises a dryer configured to perform primary drying of the web. In these examples, the apparatus according to the first aspect is configured to receive the web after primary drying for secondary drying of the web. In other words, the coating system uses a two-stage drying process. The dryer (which may be understood as a primary dryer) is configured to perform the initial drying of the coated web to remove a significant portion of the moisture or solvent. The apparatus according to the first aspect (which may be understood as a secondary dryer) is configured to receive the web after primary drying and perform secondary drying, ensuring precise moisture or solvent removal to meet final product specifications. Primary drying removes most of the moisture or solvent from the coating, allowing the secondary drying stage to focus on fine-tuning the final moisture levels. This makes the coating system ideal for thicker coatings, multi-layer coatings, or high-viscosity coating materials, ensuring complete and uniform drying.

According to some examples, the apparatus according to the first aspect is configured to output part of the drying air after it has passed along the web to the dryer for reuse by the dryer in the primary drying of the web. In other words, the output drying air is redirected to the primary dryer, where it contributes to the primary drying of the web. For example, the apparatus according to the first aspect may use the outlet described above to output part of the drying air to the dryer. By reusing the drying air, the coating system minimizes the need for external air for the primary dryer. The air from the secondary stage retains residual heat and drying capacity, reducing energy consumption. This lowers operational costs and makes the system more efficient and sustainable.

In some examples, the coating system further comprises a dry room for further processing of the web after the secondary drying. The dry room is a controlled environment configured to maintain extremely low levels of humidity and high air cleanliness, ensuring optimal conditions for processing moisture-sensitive materials such as the coated web. The dry room may be equipped with humidity control systems, such as dehumidifiers, to achieve and maintain a specified dew point (e.g., −30° C. or lower). It may also include air filtration systems to prevent contamination from dust, particles, or other environmental impurities. The dry room is configured to support post-drying operations such as cutting, laminating, assembling, or inspecting. The apparatus according to the first aspect is configured to receive the drying air from the dry room. For example, the apparatus according to the first aspect may use the inlet described above to receive the drying air from the dry room. The apparatus according to the first aspect uses ultra-dry air from the dry room, maintaining low moisture levels during the drying process. Accordingly, the drying air in the apparatus according to the first aspect matches the dew point set by the dry room. This ensures efficient and complete drying, critical for moisture-sensitive coatings and applications. The inclusion of a dry room allows the web to move directly from the drying apparatus into further processing without exposure to ambient humidity or contaminants. This minimizes the risk of defects such as moisture reabsorption or surface contamination.

In examples in which the apparatus according to the first aspect receives the drying air from the dry room, the recirculation (recycling) of the drying air may be omitted such that the apparatus receives the drying air from the dry room, runs it along the web and the exhaust is out (with no recirculation). The exhausted drying air is still useful and may be used by other drying facilities of the coating system such as the primary dryer upstream of the apparatus according to the first aspect. While this eliminates the recycling system of the apparatus according to the first aspect and, hence, reduces the complexity and the operational costs of the apparatus, the load of the dry room is increased. In alternative examples, the recirculation (recycling) of the drying air may be kept and the dry room may be used as source for, e.g., the supplemental air.

It should be noted that in alternative examples, the apparatus according to the first aspect may be the only dryer of the coating system. In other words, no primary dryer may be arranged upstream of the apparatus according to the first aspect (i.e., between the coating device and the apparatus according to the first aspect).

According to a third aspect, the present disclosure provides a method for drying a web coated with material. The method comprises guiding the web along a linear path. In addition, the method comprises causing a flow of drying air along the web for drying the web.

Like the apparatus according to the first aspect, the method according to the third aspect allows to substantially reduce drying time and increase production throughput. Additionally, the method according to the third aspect allows to achieve effective drying using room temperature air at high velocities, eliminating the need for vacuum pumps or heaters, thereby lowering operational and energy costs. The method according to the third aspect enables efficient and continuous drying of webs coated with material, enhancing production speed and simplifying the drying process.

### BRIEF DESCRIPTION OF THE FIGURES

Some examples of apparatuses and/or methods will be described in the following by way of example only, and with reference to the accompanying figures, in which

FIG. 1 illustrates a first exemplary apparatus for drying a web coated with material;

FIG. 2 illustrates a second exemplary apparatus for drying a web coated with material;

FIG. 3 illustrates a third exemplary apparatus for drying a web coated with material;

FIG. 4 illustrates a fourth exemplary apparatus for drying a web coated with material;

FIG. 5 illustrates an example of a coating system; and

FIG. 6 illustrates a flowchart of an example of a method for drying a web coated with material.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

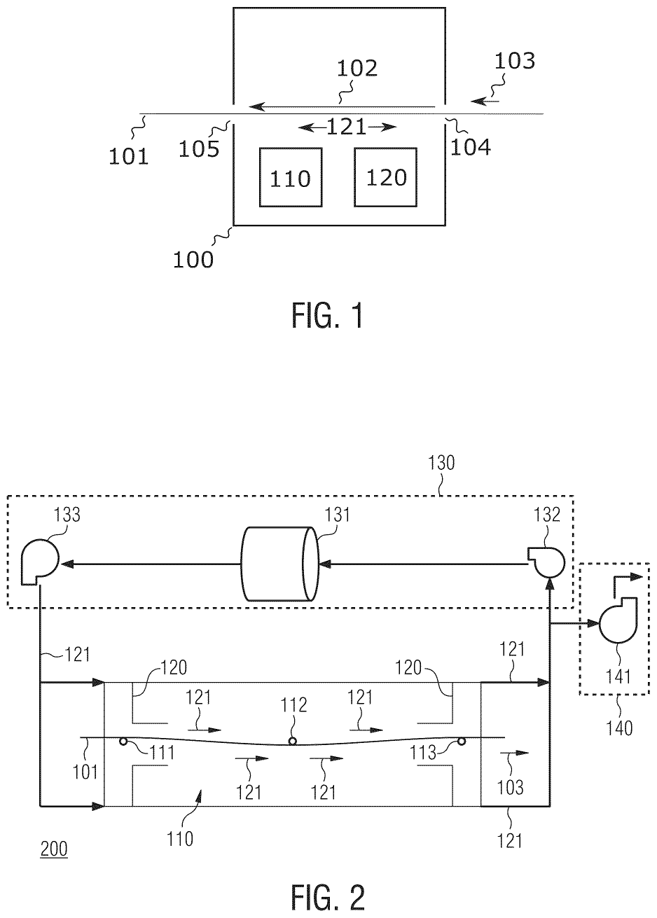

FIG. 1 schematically illustrates a first exemplary apparatus 100 for drying a web 101 coated with coating material. In the example of FIG. 1, the transport direction 103 of the web 101 is from right to left. The web 101 enters the apparatus 100 at a web inlet 104 and exits the apparatus 100 at a web outlet 104. For example, the web 101 may be received from a coating device coating the web 101 with the coating material or from an upstream (primary) dryer pre-drying the web 101. In other words, the web 101 may be a pre-dried web.

As described above, the web 101 and the coating material may vary depending on the application. For example, in the production of electrodes for batteries, the web may be a thin metal foil (e.g., copper for anodes and aluminum for cathodes) and the coating material may be a mixture of active material (such as graphite for anodes or lithium cobalt oxide for cathodes) mixed with a binder (e.g., PVDF) and conductive additives (e.g., carbon black) suspended in a solvent (e.g., NMP).

The apparatus 100 comprises a guiding system 110 configured to guide the web 101 along a linear path 102 through the apparatus 100. As the structure of the guiding system 110 may vary (see FIGS. 2 to 4 for exemplary structures), the guiding system 110 is schematically depicted as a square in FIG. 1. The linear path 102 may be geometrically straight as illustrated in FIG. 1 or represent a general direction of movement, allowing for cross-apparatus movements or oscillations of the web 101 around the linear path during transport.

Additionally, the apparatus comprises an air flow system 120 configured to cause a flow of drying air 121 along the web 101 for drying the web 101. As indicated by the two arrows left and right of reference numeral 121 in FIG. 1, the air flow system 120 may be configured to direct the drying air 121 in the same direction as the transport direction 103 of the web 101 or in a direction opposite to a transport direction 103 of the web 101.

In case the bottom and top surfaces of the web 101 are coated with the coating material, the air flow system 120 may be configured to direct the drying air 121 along both surfaces of the web 101. In particular, the air flow system 120 may be configured to direct equal amounts of drying air 121 along both surfaces of the web 101 (the same volume or mass of drying air per unit time). In case only one of the bottom and top surfaces of the web 101 is coated with the coating material, the air flow system 120 may be configured to direct the drying air 121 along both surfaces of the web 101 or only along the surface of the web 101 coated with the coating material.

The passage of the drying air 121 along the web 101 causes desorption of moisture or solvent from the web 101 and the coating material formed on the web 101. The desorption may be described with below mathematical expression (1):

$$R = {ve}^{- \frac{Ea}{kT}} Θ ( 1 - Θ ) \qquad ( 1 )$$

with R denoting the desorption rate (e.g., in milligram per minute or similar units), v denoting the attempt frequency or the attempts a particle takes to leave the coating material or the web 101, Ea denoting the activation energy or the energy needed to start the process, k denoting the Boltzmann constant, T denoting the temperate (in units of Kelvin) and Θ denoting the surface coverage.

Θ is defined in below mathematical expression (2):

$$Θ = \frac{P}{P - {P}_{des}} \qquad ( 2 )$$

with P denoting the equilibrium pressure of the desorbed and P_{des} denoting the pressure at which half of the surface sites are occupied by the desorbed molecules. In other words, P denotes the pressure above the coating material and P_{des} denotes the pressure in the coating material, which may be assumed to be atmospheric pressure. By combining mathematical expressions (1) and (2), the dependency of the desorption rate and the pressure and the temperature may be seen:

$$R = \frac{{ve}^{- \frac{Ea}{kT}} {PP}_{des}}{{( P - {P}_{des} )}^{2}} \qquad ( 3 )$$

Mathematical expression (3) shows that the lower the pressure P is above the web 101, the higher is the rate of desorption. The temperature T does not have large influence on the desorption rate, specifically in the temperature ranges that coating materials can typically withstand.

The apparatus 100 makes use of this finding and guides the drying air 121 along the web 101. Particularly, the apparatus 100 may achieve effective drying using dry room temperature air at high velocities, eliminating the need for vacuum pumps or heaters, thereby lowering operational and energy costs. Accordingly, efficient and continuous drying of the coated web 101 may be achieved by the apparatus 100, enhancing production speed and simplifying the drying process. For example, the drying air 121 may be at a temperature of 30° C. or lower and a dew point of the drying air 121 may be −30° C. or below. Depending on the structure of the guiding system 110, the velocity of the drying air 121 may vary. For example, if the guiding system 110 comprises rollers for guiding the web along the linear path 102, the air flow system 120 may be configured to direct the drying air 121 at a velocity of at least 1.25 meters per second (in particular 2.5 meters per second) along the web 101. If the guiding system 110 comprises air bars on both sides of the web, the air bars may be configured to direct the drying air 121 to the respective surface of the web 101 at a velocity of at least 15 meters per second (in particular about 30.5 meters per second).

The guidance of the web 101 along the linear path 102 allows to reduce the volume of the apparatus 100 compared to conventional batch vacuum dryers. Using drying air of sufficiently high velocities allows to substantially reduce drying time and increase production throughput. This allows to place the apparatus 100 directly in line with a primary dryer, or on a separate web handling system on manufacturing lines-depending on the needs of the manufacturer.

FIG. 2 schematically illustrates another exemplary apparatus 200 for drying a web 101 coated with coating material. Like the apparatus 100, also the apparatus 200 comprises a guiding system 110 configured to guide the web 101 along a linear path 102 through the apparatus 200. In the example of FIG. 2, the guiding system 110 comprises a plurality of rollers configured to guide the web 101 along the linear path 102. Three rollers 111, 112 and 113 are exemplarily illustrated in FIG. 2. However, it should be noted that any number N>2 of rollers may be used. The plurality of rollers may be distributed evenly along the linear path 102-either above and below the web 101 as illustrated in FIG. 1, or only (exclusively) below the web 101.

Analogously to what is described above, an air flow system 120 of the apparatus 200 is configured to cause a flow of drying air 121 along the web 101 for drying the web 101. In the example of FIG. 2, the air flow system 120 is configured to cause the flow of drying air 121 parallel to the linear path 102. The drying air 121 moves along the web 101 rather than being impinged directly onto the web 101. The air flow system 120 is configured to direct the drying air 121 along both surfaces of the web 101. The transport direction 103 of the web 101 is from left to right in the example of FIG. 2 (but may be reversed in alternative examples). Also the drying air flows from left to right. In other words, the air flow system 120 is configured to direct the drying air 121 in the same direction as a transport direction 103 of the web 101. However, it should be noted that the air flow system 120 may alternatively be configured to direct the drying air 121 in a direction opposite to the transport direction 103 of the web 101. The drying air 121 may be at a temperature of 30° C. or lower and a dew point of the drying air 121 may be −30° C. or below. The air flow system 120 may be configured to direct the drying air 121 at a velocity of at least 1.25 meters per second (in particular 2.5 meters per second) along the web 101.

Also the apparatus 200 allows to achieve effective drying at reduced dry times using dry room temperature air at high velocities.

The apparatus 200 additionally comprises an outlet 140 for outputting part of the drying air 121 after it has passed along the web 101 to an external device for reuse. For example, the outlet 140 may comprise a fan 141 and further flow control mechanisms such as valves and ducts to guide the exhaust air of the apparatus 200 to the external device for reuse. The external device may, e.g., be a primary dryer upstream of the apparatus 200.

The apparatus 200 further comprises a recycling system 130 configured to receive the other part of the drying air 121 after it has passed along the web 101. The recycling system 130 may receive the majority (i.e., more than 50%) of the drying air 121 after it has passed along the web 101. The recycling system 130 is configured to condition the received drying air 121. The recycling system 130 illustrated in FIG. 2 comprises a dehumidifier 133 such as a desiccant wheel dehumidifier configured to reduce the moisture content of the received drying air 121 to condition it for reuse in the apparatus. Accordingly, a consistent (predefined) dew point of the drying air 121 may be ensured. In other examples, the conditioning of the received drying air 121 may comprise more or other processes than the dehumidification illustrated in FIG. 1.

The recycling system 130 is configured to supply the conditioned air to the air flow system 120 for reuse in the apparatus 200. A fan 133 is illustrated in FIG. 2 to indicate the supply of the conditioned air back to the air flow system 120 for reuse in the apparatus 200.

Further illustrated in FIG. 2 is another fan 132 to indicate that the recycling system 130 is configured to receive supplemental air (make up air) and mix it with the received drying air 121. In the example of FIG. 2, the supplemental air is introduced before dehumidification, i.e., upstream of the dehumidifier 133. In alternative examples, the supplemental air is introduced after dehumidification, i.e., downstream of the dehumidifier 133.

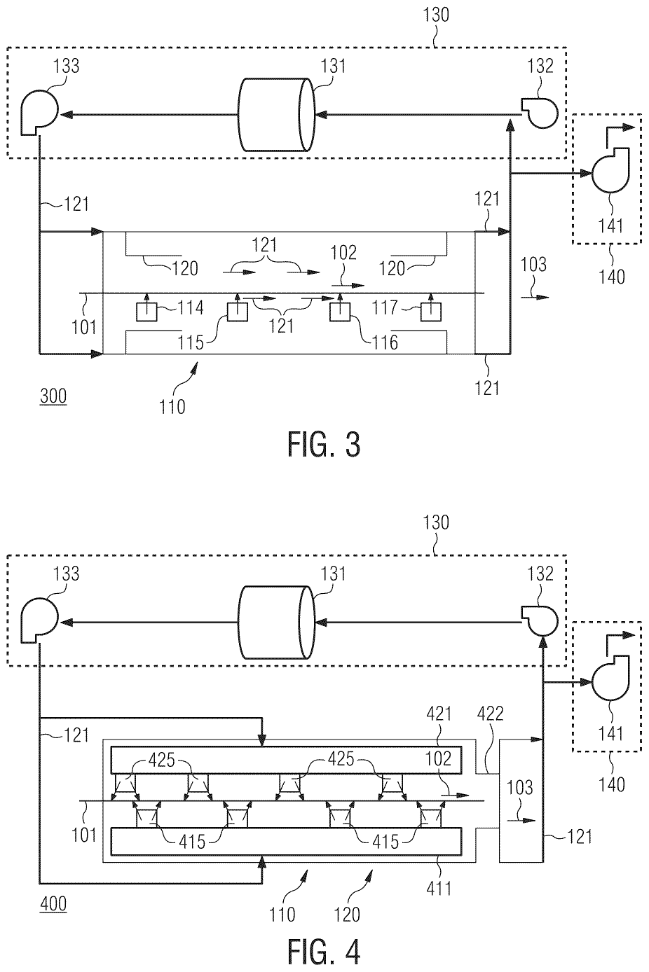

FIG. 3 illustrates another exemplary apparatus 300 for drying a web 101 coated with coating material. In comparison to the apparatus 200, the plurality of rollers 111, 112, 113 of the guiding system 110 are replaced by a plurality of air bars 114, 115, 116 and 117 arranged below the web.

Four air bars 114, 115, 116 and 117 are exemplarily illustrated in FIG. 3. However, it should be noted that any number M≥2 of air bars may be used. The plurality of air bars 114, 115, 116 and 117 may be distributed evenly along the linear path 102. The air bars 114, 115, 116 and 117 are configured to guide the web 101 along the linear path 102 by generating an airflow that floats the web 101 above the air bars 114, 115, 116 and 117. The air bars 114, 115, 116 and 117 generate an upward airflow that creates a cushion of air, allowing the web 101 to float above the air bars 114, 115, 116 and 117 as it moves along the linear path 102. For example, the air bars 114, 115, 116 and 117 may be StepFoil® or Hi-Float® style air bars of Duerr Systems, however other types of air bars may be used as well. The air bars 114, 115, 116 and 117 only need to float the web 101, which allows to minimize the number of air bars. The parallel air flow caused by the air flow system 120 does most of the drying of the coated web 101.

FIG. 4 illustrates another exemplary apparatus 400 for drying a web 101 coated with coating material. In comparison to the apparatus 300, two sets of air bars 415 and 425 are placed above and below the web 101 instead of only air bars below the web 101. In the apparatus 400, the guiding system 110 and the air flow system 120 are formed jointly.

The guiding system 110 and the air flow system 120 comprise the first set of horizontally spaced apart air bars 415 placed below the web 101, and the second set of horizontally spaced apart air bars 425 place above the web 101. The air bars in each set 415, 425 are horizontally spaced apart from each other by a distance of at least 38 centimeters (15 inches) along the transport direction 103 of the web 101. For example, the air bars in each set 415, 425 may be horizontally spaced apart from each other by a distance between 38 centimeters (15 inches) and 76 centimeters (30 inches). This horizontal spacing ensures proper airflow distribution and stability.

The air bars in the first set 415 are configured to direct drying air 121 at one or more angles to the bottom first surface of the web 101 as indicated by the arrows in FIG. 4. Analogously, the air bars in the second set 425 are configured to direct the drying air at one or more angles to the top surface of the web 101 (e.g., one or more angles smaller than 90° relative to the respective surface of the web 101). The drying air 121 is directed to pass along the web 101 to guide the web 101 between the sets of air bars 415, 425 and to dry the web 101. The drying air 121 moves along the web 101 rather than being impinged directly onto the web 101. Two headers 411 and 421 of the air flow system 120 supply the drying air 121 to the air bars of the respective set 415, 425. The drying air 121 is recycled like in the previous examples by the recycling system 130. A collection member of the air flow system 120 collects the drying air 121 after it has passed along the web 101 and passes it to the recycling system and the outlet 140.

Four air bars are exemplarily illustrated in FIG. 4 for each of the sets 415 and 425. However, it should be noted that any number M≥2 of air bars may be used per set. The plurality of air bars may be distributed evenly along the linear path 102.

The sets of air bars 415, 425 serve dual purposes: 1) guiding the web 101 by creating stabilizing airflow to maintain alignment, and 2) drying the web 101 by directing controlled air along the web 101 to evaporate moisture or solvents from the coated material. The first set of air bars 415 and the second set of air bars 425 are positioned at different vertical levels within the apparatus 400, with the web 101 passing between them. The air bars in the first and second sets 415, 425 direct air to the top and bottom surfaces of the web 101 simultaneously, ensuring uniform drying. By integrating guiding and drying systems into a single design, the apparatus 400 eliminates the need for separate components, reducing mechanical complexity.

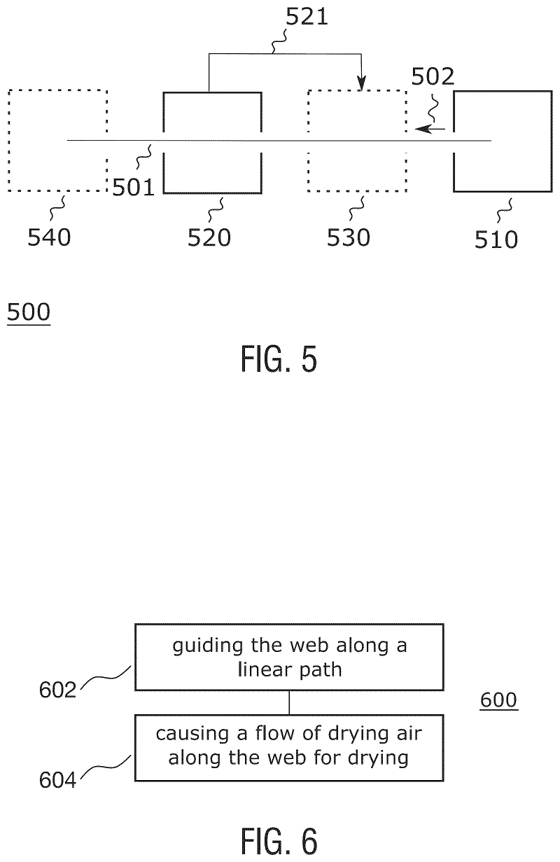

As described above, the apparatuses for drying a coated web described herein may be used for various applications. FIG. 5 illustrates an exemplary coating system 500 using the drying technology of the present application. The coating system 500 comprises a coating device 510 and an apparatus 520 for drying a web 501 coated with coating material as described herein. The coating device 510 is arranged upstream of the apparatus 520 and configured to coat the web 501 with the coating material. In the example of FIG. 5, the transport direction 502 of the web 501 is from right to left. For example, the coating system 500 may be used for the manufacture of battery electrodes (e.g., apply a mixture of active material mixed with a and conductive additives suspended in a solvent to a thin metal foil), printed electronics (e.g., apply conductive inks or materials only to specific areas of a substrate for circuit paths, etc.) or medical devices (e.g., coat specific parts of medical devices or implants with biocompatible or drug-releasing materials).

The apparatus 520 supports high-throughput manufacturing, making the coating system 500 suitable for industrial-scale applications. Additionally, operational and energy costs may be lowered compared to conventional coating systems as the apparatus 520 does not need vacuum pumps or heaters.

The apparatus 520 may be the only dryer of the coating system 500 such that the apparatus 520 dries the coated web 501 immediately after it is released by the coating device 510.

In other examples, a primary dryer 530 may be arranged upstream of the apparatus 520 (i.e., between the coating device 510 and the apparatus 520). That is, the coating system 500 may optionally further comprise the primary dryer 530. The primary dryer 530 is configured to perform primary drying of the web 501. The apparatus 520 (acting as a secondary dryer) is configured to receive the web 501 after primary drying and perform secondary drying, ensuring precise moisture or solvent removal to meet final product specifications.

The apparatus 520 is configured to output part of the drying air 521 after it has passed along the web 501 to the dryer 530 for reuse by the dryer 530 in the primary drying of the web 501 (e.g., via a corresponding outlet as described above). By reusing the drying air 521, the coating system 500 minimizes the need for external air for the primary dryer 530. The air from the secondary drying stage retains residual heat and drying capacity, reducing energy consumption. This lowers operational costs and makes the system more efficient and sustainable.

Optionally, the coating system 500 may further comprise a dry room 540 for further processing of the web after the secondary drying (e.g., cutting, laminating, assembling, or inspecting of the web 501). The apparatus 530 may be configured to receive the drying air 521 from the dry room 540 (e.g., via a corresponding inlet as described above). The apparatus 520 uses ultra-dry air from the dry room 540 in these examples, maintaining low moisture levels during the drying process. This ensures efficient and complete drying, critical for moisture-sensitive coatings and applications.

For further highlighting the web drying described above, FIG. 6 illustrates a flowchart of a method 600 for drying a web coated with coating material. The method 600 comprises guiding 602 the web along a linear path. In addition, the method 600 comprises causing 604 a flow of drying air along the web for drying the web.

Analogously to what is described above, the method 600 may allow to substantially reduce drying time and increase production throughput. Additionally, the method 600 may allow to achieve effective drying using room temperature air at high velocities, eliminating the need for vacuum pumps or heaters, thereby lowering operational and energy costs. The method 600 may enable efficient and continuous drying of webs coated with material, enhancing production speed and simplifying the drying process.

More details and aspects of the method 600 are explained in connection with the proposed technique or one or more example described above (e.g. FIGS. 1 to 5). The method 600 may comprise one or more additional optional feature corresponding to one or more aspect of the proposed technique or one or more example described above.

The web drying described above may, e.g., be used for battery electrode post drying during battery electrode manufacturing. For most battery applications, the moisture content of the final electrode material should be in the 200 to 300 ppm and below range. Conventional dryers designed for drying wet coated battery electrodes may take the moisture level in the coating down to between 0.5 to 0.1% residual moisture, but then a different process is typically needed to get the moisture level down to the ppm level. The web drying described above allows to reduce the moisture content to the target moisture levels. However, it is also applicable to other applications that require a porous coating to be dried down to below 0.5% residual moisture, i.e., 5000 ppm.

Due to the flexibility of the design of the above apparatuses for web drying (and them being roll-to-roll systems), the above apparatuses for web drying may be integrated into already existing web handling system and be in line with existing primary drying steps. Otherwise, the above apparatuses for web drying may be used out of line and have their own web handling system so that they can operate as independent systems.

The aspects and features described in relation to a particular one of the previous examples may also be combined with one or more of the further examples to replace an identical or similar feature of that further example or to additionally introduce the features into the further example.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps-functions-processes oroperations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for drying a web coated with material, comprising:
a guiding system configured to guide the web along a linear path through the apparatus; and
an air flow system configured to cause a flow of drying air along the web for drying the web.

2. The apparatus of claim 1, wherein the guiding system comprises a plurality of rollers configured to guide the web along the linear path.

3. The apparatus of claim 1, wherein the guiding system comprises a plurality of air bars arranged below the web and configured to guide the web along the linear path by generating an airflow that floats the web above the air bars.

4. The apparatus of claim 1, wherein the web has two opposite surfaces, each coated with the material, and wherein the air flow system is configured to direct the drying air along both surfaces of the web.

5. The apparatus of claim 4, wherein the air flow system is configured to direct equal amounts of drying air along both surfaces of the web.

6. The apparatus of claim 1, wherein the air flow system is configured to direct the drying air in a same direction as a transport direction of the web.

7. The apparatus of claim 1, wherein the air flow system is configured to direct the drying air in a direction opposite to a transport direction of the web.

8. The apparatus of claim 1, wherein the air flow system is configured to cause the flow of drying air parallel to the linear path.

9. The apparatus of claim 1, wherein the air flow system is configured to direct drying air at a velocity of at least 1.25 meters per second along the web.

10. The apparatus of claim 1, wherein the guiding system and the air flow system are formed jointly and comprise:
a first set of horizontally spaced apart air bars; and
a second set of horizontally spaced apart air bars,
wherein the first and second sets of air bars are vertically spaced apart from each other,
wherein the air bars in each set are horizontally spaced apart from each other by a distance of at least 38 centimeters, and
wherein the air bars in the first set are configured to direct drying air at one or more angles to a first surface of the web, and the air bars in the second set are configured to direct the drying air at one or more angles to an opposite second surface of the web, the drying air being directed to pass along the web to guide the web between the sets of air bars and to dry the web.

11. The apparatus of claim 10, wherein the air bars in each set are horizontally spaced apart from each other by a distance of less than 80 cm.

12. The apparatus of claim 1, wherein the drying air is at a temperature of 30° C. or lower.

13. The apparatus of claim 1, wherein a dew point of the drying air is −30° C. or below.

14. The apparatus of claim 1, further comprising an outlet for outputting part of the drying air after it has passed along the web to an external device for reuse.

15. The apparatus of claim 1, further comprising a recycling system configured to:
receive at least part of the drying air after it has passed along the web;
condition the received drying air; and
supply the conditioned air to the air flow system for reuse in the apparatus.

16. The apparatus of claim 15, wherein the recycling system comprises a dehumidifier configured to reduce the moisture content of the received drying air to condition it for reuse in the apparatus.

17. The apparatus of claim 15, wherein the recycling system is configured to receive supplemental air and mix it with the received drying air.

18. The apparatus of claim 1, further comprising an inlet for coupling to an external source providing the drying air.

19. A system comprising:
an apparatus for drying a web coated with material, comprising:
a guiding system configured to guide the web along a linear path through the apparatus; and
an air flow system configured to cause a flow of drying air along the web for drying the web; and
a coating device configured to coat the web with the material.

20. The system of claim 19, further comprising:
a dryer configured to perform primary drying of the web,
wherein the apparatus is configured to receive the web after primary drying for secondary drying of the web.

21. The system of claim 19, wherein the apparatus is configured to output part of the drying air after it has passed along the web to the dryer for reuse by the dryer in the primary drying of the web.

22. The system of claim 19, further comprising:
a dry room for further processing of the web after the secondary drying,
wherein the apparatus is configured to receive the drying air from the dry room.

23. A method for drying a web coated with material, comprising:
guiding the web along a linear path; and
causing a flow of drying air along the web for drying the web.
